(19) United States
(12) Patent Application Publication
(10) Pub. No.: US 2001/0037534 A1
(43) Pub. Date: Nov. 8, 2001

(54) Drywall tool

(76) Inventor: Kern E. Bryan, Albuquerque, NM (US)

Correspondence Address: KENEHAN & LAMBERTSEN, LTD, 1771 E. FLAMINGO ROAD, SUITE 211-B, LAS VEGAS, NV, 89119-5154, US

(21) Appl. No.: 09/764,649

(22) Filed: Jan. 16, 2001

Related U.S. Application Data
(60) Provisional application No. 60/176,471, filed on Jan. 16, 2000.

(51) Int. Cl. B25G 1/06

(52) U.S. Cl. 15/144.1; 15/172; 15/236.01; 118/504

(57) ABSTRACT

An applicator for surface treatment tools, such as drywall knockdown blades, wire brushes, scrapers, putty knives, and the like provides a rotatable bracket attached to a handle. Attachment of the surface tool to the bracket permits variance to the angular positioning between the handle and the surface tool as required by the positioning of the tool operator and/or the surface to be worked relative to the positioning of the tool operator. Set angular positions are provided by the bracket, with changes in positioning requiring actuation of an internal locking mechanism by the operator during use of the tool.

### CROSS-REFERENCE TO RELATED APPLICATION

This application claims the benefit of U.S. Provisional Application, Serial No. 60/176,471, filed Jan. 16, 2000.

### BACKGROUND OF THE INVENTION

1. Field of the Invention

The present invention relates to hand-held tools and, more particularly, to such tools as are useful for surface preparation and finishing operations. More specifically, the present invention relates to an extension and rotatable base support for the attachment of hand tools used in the surface preparation, application, and finishing treatments for drywall surfaces.

2. Description of the Prior Art

Traditional plaster walls require a labor-intensive fabrication process. Employment of the skilled laborers required for such a process runs counter to present trends in the commercial and home construction industry. Emphasis today is on speed, efficiency, and cost-effectiveness towards the completion and profitability of construction projects. Competitive bidding pressures have made it increasingly difficult to rely on anything other than unskilled labor when bidding a construction project.

Except for the most expensive of custom installations, gypsum wallboard, also know as “dry wall” has completely replaced plaster in the construction of walls and ceilings in modern homes and offices. Gypsum board retains the fire-resistant characteristics of gypsum plaster and can be installed with much less labor using less-skilled workers. In addition, the use of dry wall brings very little “water” into a building, and thereby eliminates some of the waiting required with the curing and drying of gypsum plaster.

For most commercial and home construction projects, dry wall is cut into rectangular sheets of four (4) feet by eight-to-twelve (8-12) feet, of one-half to five-eighths inch thickness. Installation of the dry wall can occur over either steel or wood studs using self-tapping screws (metal studs) and either screws or nails (wood) to fasten the dry wall to the support. After installation of the dry wall is complete, all of the joints between the boards and the indentations left by the nailing or screw attachments must be filled and smoothed before the surface of the dry wall is ready for final texturing or finishing.

Additionally, most dry wall panels used in finished wall constructions have a tapered edge. When placed edge-to-edge, the tapering is part of a joint finishing process that results in the formation of a flush, invisible seam between adjacent panels. After being placed together, adjacent one another, a layer of joint compound or plaster (either/both termed “mud”) is troweled into the tapered edge joint. A paper or glass fiber reinforcing tape is then placed over the joint and covered with an additional layer of the joint compound. These first layers are allowed to dry and one or two finishing coats of the joint compound are then applied and sanded. A properly finished joint forms a wall that appears to be made of a solid sheet rather than discreet panels.

Various types of wipe down tools, knives, and scrapers are used to smooth the mud used to create a flat, finished wall. Many times the tool itself creates a marking in the mud that requires repeated passing and feathering to remove. With typical walls extending above the reach of most workers, ladders or stilts are frequently required, both of which tend to interfere with the pace of work. Additionally, wall borders and edges require manipulation of the tool edge, precluding any rigid attachment to a pole or other reach-extender.

It is thus a primary object of the present invention to provide a tool extender system that permits adjustment of the tool edge or surface relative to the extended handle permitting ease of use at various work surface elevations and in areas where access is restricted.

### SUMMARY OF THE IVENTION

It is an object of the present invention to provide an applicator for use with surface treatment tools that includes a rotatable mounting bracket, a handle attached to the mounting bracket, and a place on the mounting bracket to releasibly attache a surface tool, such as a drywall knockdown blade. The rotatable mounting bracket has a plurality of fixed angular positions relative to the handle, and an internal locking mechanism to retain the mounting bracket in a desired position during use of the tool.

The rotatable mounting bracket includes an outer casement that contains an internal angular locking plate having a number of positioning apertures formed therein. A locking pin is also retained within the casement and a portion of the pin is selectively received by the positioning apertures, thus retaining the locking plate in position relative to the outer casement. A pivotal actuator is interlinked with the locking pin in a manner permitting the tool operator to disengage the locking pin from the positioning aperture when rotation of the locking plate to another positioning aperture is desired.

Some further objects and advantages of the present invention shall become apparent from the ensuing description and as illustrated in the accompanying drawings.

### BRIEF DESCRIPTION OF THE DRAWINGS

FIG. 1 is a perspective view of a tool holder showing a knockdown blade positioned therein in accordance with the present invention;

FIG. 2 is an exploded perspective view, with portions broken away, showing the tool holder and knockdown blade depicted in FIG. 1;

FIG. 3 is a partial enlarged view taken within circle 3 of FIG. 1, in accordance with the present invention;

FIG. 4 is an enlarged partial perspective view showing an alternative angular tool adjustment mechanism in accordance with the present invention; and

FIG. 5 is a partial exploded view, in perspective, showing an alternative tool connector in use with the angular tool adjustment mechanism in accordance with the present invention.

### DETAILED DESCRIPTION OF PREFERRED EMBODIMENTS

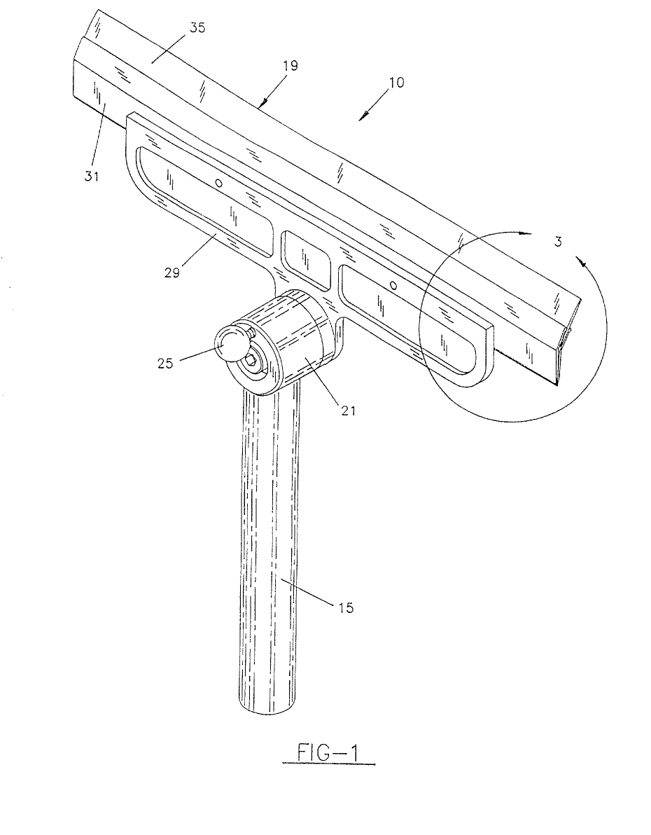

Reference is now made to the drawings wherein like numerals refer to like parts throughout. A knockdown tool 10 is shown in FIG. 1, having a handle 15 to which is attached a head assembly 19 using a mounting bracket 21. The mounting bracket 21 permits relative angular movement between the handle 15 and the head assembly 19. A release 25 is provided the mounting bracket to enable the user to control such angular relative positioning.

The head assembly 19 consists of a support frame 29 to which is attached a blade assembly 31 when utilized as the knockdown tool 10 depicted in FIG. 1. A flexible blade 35 projects from the blade assembly 31, and is preferably utilized by being dragged across a planar surface to which a coating of “mud” has been applied (not shown in the Figures) to provide a textured surface thereto.

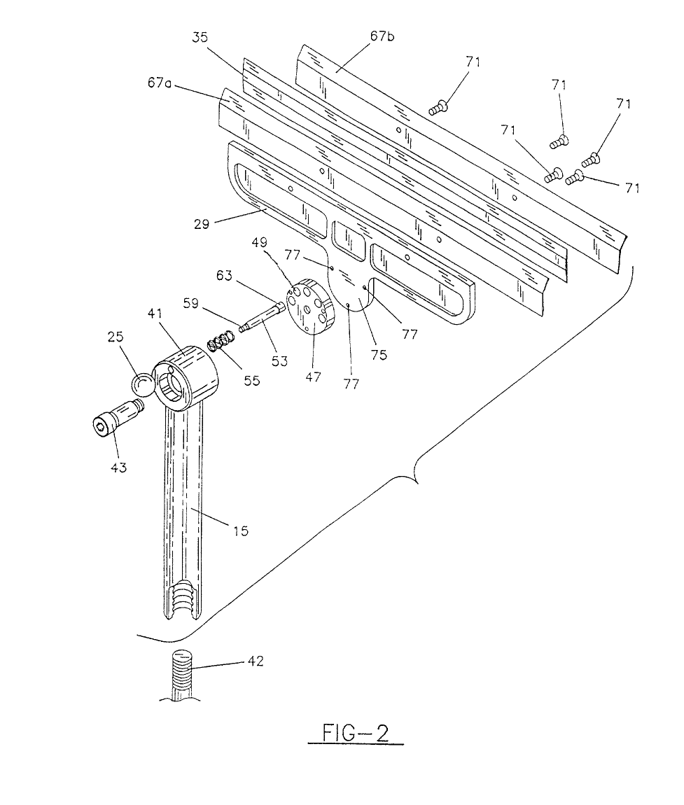

The manner of construction of the mounting bracket 21 is best described with reference to FIG. 2. A casement 41 is formed on or attached to the handle 15 and, perhaps, a handle extension 42. A connector bolt 43 extends through the casement 41 and attaches to an angular locking plate 47, in which a plurality of positioning apertures are formed. A release bolt 53 also extends through the casement 41, with a release spring 55 received thereon.

A first end of the release bolt 53 terminates in a threaded terminus 59, and a second end forms a shoulder 63. Upon extending through the casement 41, the release 25 is received by and attaches to the threaded terminus 59, retaining the release bolt 53 within the casement 41. The shoulder 63 is configured in a manner to be received within a selected one of the plurality of positioning apertures 49.

Upon attachment of the release bolt 53 to the casement 41 using the release 25, the release spring 55 biases the release bolt 53 towards the angular locking plate 47, securing the shoulder of the release bolt within the selected one of the positioning aperture 49. At such time as it is desired to change the angular positioning of the head assembly 19 (FIG. 1) relative to the handle 15, the release 25 is pulled away from the mounting bracket 21, releasing the shoulder 63 of the release bolt 53 from its position within one of the positioning apertures 49. The head assembly 19 is then rotated, until a desired new positioning aperture of the plurality of positioning apertures 49 underlies the shoulder 63. The release 25 is then permitted to re-establish its position adjacent the mounting bracket 21 under the biasing force of the release spring 55, which in turn seats the shoulder 63 within the positioning aperture.

When utilized as a knockdown tool in accordance with the present invention, the head assembly 19 (FIG. 1) consists of multiple separate parts. Turning again to FIG. 2, the flexible blade 35 is held between a pair of rigid blade guides 67a, 67b, with a plurality of fasteners 71 used to assemble the blade and blade guides, and to attach the resultant assembly to the support frame 29. As is best shown with reference to FIG. 3, the use of the blade guides 67 enables the flexible blade 35 to be held at an angle to the work surface. Such positioning of the blade is in contrast to presently-used flat blades, which push against a wall to create a rough texture that must be sanded down before paint can be applied to the wall. The angled blade of the present invention does not form a rough edge, and as a result creates a smooth surface that requires no sanding before the application of paint.

Returning once again to FIG. 2, an attachment surface 75 is formed in the support frame 29, and is sized to receive the angular locking plate 47. Attachment follows using any of a variety of conventional attachment methods, such as removable threaded bolts (not shown) received in a plurality of attachment apertures 77 in the attachment surface 75 in FIG. 2. In this manner, the head assembly can be easily separated from the mounting bracket and handle, should employment of a different tool be desired.

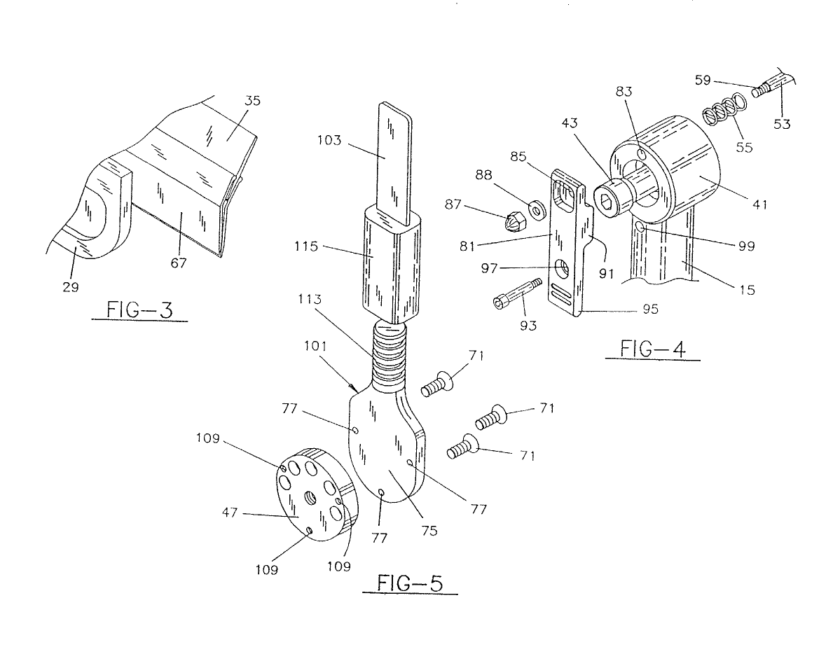

In FIG. 4, an alternative is shown to the release 25 for initiating the angular rotation of the head assembly 29 (not shown) relative to the handle 15. A pivotal reciprocating actuator 81 is attached to the casement 41 in a manner that permits actuation of the release bolt 53 by a simple rocking activation by the user. After passage through a casement bolt passage 83 in the casement 41, the release bolt 53 extends through an attachment throughbore formed in the pivotal actuator 81.

A cap nut 87 is received upon the threaded terminus of the release bolt 53, with a flat washer 88 assisting in the securement of the pivotal reciprocating actuator 81 to the casement 41. A pivot surface 91 formed on the pivotal actuator 81 rests against the end of the connector bolt 43 that extends from the casement 41. Positional securement of the pivotal reciprocating actuator 81 is provided by the use of a guide bolt 93 that passes through the pressure foot portion 95 of the pivotal actuator 81 through a guide bolt throughbore 97 formed therein. A tapped opening 99 formed in the handle 15 receives the guide bolt 93 and secures it in position relative to the casement 41. In this manner, upon pressure being applied by the user against the pressure foot 95, the pivotal reciprocating actuator 81 pivots about the pivot surface 91, resulting in the retraction of the release bolt 53 from its spring-biased engagement with the positioning apertures 49 formed in the angular locking plate 47 (not shown in FIG. 4).

As briefly noted previously, the attachment of other tools besides the knockdown tool 10 of FIG. 1 is contemplated under the present invention. In FIG. a tool support plate 101 is provided to enable the attachment of multiple different tools, including a scraper 103. The tool support plate 101 makes use of the attachment surface 75 to receive the angular locking plate 47 in exactly the same manner as did the support frame 29 of the knockdown tool 10. A plurality of plate fasteners 105 are received within the attachment apertures 77, extending into a corresponding plurality of threaded connection apertures 109 formed in the angular locking plate 47.

In accordance with a preferred embodiment, each of the various tools is secured to the tool support plate 101 using a threaded connection. A threaded extension 113 is formed on the tool support plate 101, and is received into a threaded tool base 115. In this manner replacement and removal of a particular tool may be easily accomplished.

In a preferred embodiment, the knockdown tool 10 is fabricated out of more than one material. The handle 15 is preferably made out of plastic, phenolic or metal, and is typically 1″ in diameter and 12″ in length. The casement 41 is preferably fabricated out of plastic or metal and has dimensions of 2″ in diameter and 1″ in thickness.

When used as a knockdown tool, the head assembly 19 preferably utilizes a plastic or metal support frame 29 and blade guides 67 made out of either plastic or metal. The blade itself must be made out of a very flexible material that does not mark or otherwise discolor the surface upon which it is pressed. Presently, a polyvinyl chloride used in the form of a flexible seal for garage doors (manufactured by Marley Mouldings of Marion, Va.), provides these necessary characteristics. The length of the head assembly can vary, with lengths of 12″, 18″, and 24″ considered to be particularly useful to the trade, with the length used primarily depending upon the particular requirements of the drywall material. As noted previously, other surface treatment tools such as a wire brush, a scraper, a putty knife, a paint brush, and a paint shield can be attached using the extension and tool base exemplified by the example shown in FIG. 5.

My invention has been disclosed in terms of a preferred embodiment thereof, which provides an improved, angularly-adjustable, tool holder that is of great novelty and utility. Various changes, modifications, and alterations in the teachings of the present invention may be contemplated by those skilled in the art without departing from the intended spirit and scope thereof. It is intended that the present invention encompass such changes and modifications.

I claim:

1. An applicator for surface treatment tools, comprising:
a rotatable mounting bracket having a plurality of fixed angular positions and a locking mechanism for selecting a desired one of said plurality of angular positions;
a handle attached to said rotatable mounting bracket; and
a surface treatment tool having a treatment surface formed thereon, said surface treatment tool releasibly attached to said rotatable mounting bracket in a manner enabling a positioning of said treatment surface upon selection of said desired one of said plurality of angular positions.

2. An applicator according to claim 1, wherein said rotatable mounting bracket comprises:
an outer casement;
an angular locking plate received within said outer casement, said angular locking plate having a plurality of positioning apertures formed at angularly displaced locations therein; and
a positioning pin received within said casement and biased against said locking plate, said positioning pin received within individual ones of said plurality of positioning apertures defining said plurality of fixed angular positions of said rotatable mounting bracket.

3. An applicator according to claim 2, and further comprising a pivotal actuator interconnected with said positioning pin and having an actuator surface located outside of said casement providing access to an operator of said applicator.

4. An applicator according to claim 2, wherein said surface treatment tool is attached to said rotatable mounting bracket by a threaded extension formed on said mounting bracket.

5. An applicator according to claim 2, wherein said surface treating tool is a tool selected from the group consisting of a knockdown tool, a wire brush, a scraper, a putty knife, a paint brush or a paint shield.

6. An applicator according to claim 2, and further comprising a handle extension selectively attachable to said handle as required by an operator of said applicator.

7. A tool applicator comprising:
a handle; and
a rotatable tool receiving bracket attached to said handle, said tool receiving bracket having a tool receiving surface formed on said bracket at a location providing a plurality of specific individual angular displacements relative to said handle.

8. A tool applicator according to claim 7, wherein said rotatable tool receiving bracket comprises:
an outer casement; and
an angular locking plate rotatably received within said outer casement and defining a plurality of pre-set rotational positions relative to said outer casement.

9. A tool applicator according to claim 8, wherein said tool receiving surface is formed on said angular locking plate.

10. A tool applicator according to claim 8, and further comprising a locking pin received within said outer casement, said locking pin selectively received by said angular locking plate when said angular locking plate is positioned at one of said pre-set rotational positions relative to said outer casement, whereby said locking pin retains said locking plate as so positioned.

11. A tool applicator according to claim 10, and further comprising a pivotal actuator interlinked with said locking pin and having a portion thereof projecting outside of said outer casement, whereby actuation of said pivotal actuator enables the selective disengagement of said locking pin with said angular locking plate and the repositioning of said angular locking plate to another one of said pre-set rotational positions relative to said outer casement.
